(19) United States
(12) Patent Application Publication
(10) Pub. No.: US 2012/0088101 A1
(43) Pub. Date: Apr. 12, 2012

(54) MULTILAYER INTERLAYER POLYMER FILM FOR FIRE-SCREEN GLAZINGS AND RELATED FIRE-SCREEN PRODUCTS

(75) Inventors: Michael L. Friedman, New York, NY (US); Barbara JoAnne Lang, Palo Alto, CA (US); Boris M. Friedman, Hoboken, NJ (US); Al Ansari, Los Altos, CA (US)

(73) Assignee: LIVEGLASS, INC., Palo Alto, CA (US)

(21) Appl. No.: 13/250,374

(22) Filed: Sep. 30, 2011

Related U.S. Application Data
(60) Provisional application No. 61/391,919, filed on Oct. 11, 2010.
(60) Provisional application No. 61/394,128, filed on Oct. 18, 2010.

(51) Int. Cl. B32B 17/10; B32B 38/00; B32B 37/06; B32B 37/10; B32B 27/40; B32B 27/04

(52) U.S. Cl. 428/339; 428/423.1; 428/425.6; 428/421; 156/308.2; 156/285; 156/272.6

(57) ABSTRACT

A multilayer interlayer polymer film for use within and a high clarity and high efficiency fire-screen glazing or related fire-screen product uses a particular ordering of layers. The ordering of layers includes: (1) a core layer comprising one of a sulfur containing thermoplastic polymer material and a fluorine containing thermoplastic polymer material; (2) at least one intermediate layer laminated to the core layer and comprising the other of the sulfur containing thermoplastic polymer material and the fluorine containing thermoplastic polymer material; and (3) at least one skin layer laminated to the at least one intermediate layer and comprising a thermoplastic polyurethane material. The film provides cost effective and efficient fire-screen glazings and related fire-screen products due to the thermoplastic polyurethane polymer material and the sulfur containing thermoplastic polymer materials which also may be used in absence of the fluorine containing thermoplastic polymer material to provide an additional embodiment.

### CROSS-REFERENCE TO RELATED APPLICATIONS

This application claims priority to U.S. Provisional Patent Application Ser. No. 61/391,919, filed Oct. 11, 2010; and (2) U.S. Provisional Patent Application Ser. No. 61/394,128, filed Oct. 18, 2010, each titled “Thermoplastic Film Transparent and Opaque Fire-Screening Glazing and Fire Wall Barrier Made Using the Film,” the entirety of which is hereby incorporated by reference herein

### BACKGROUND OF THE INVENTION

1. Field of the Invention

Embodiments relate generally to interlayers used in fire-screen glazings and related fire-screen products. More particularly, embodiments relate to cost effective interlayers used in fire-screen glazings and related fire-screen products.

2. Description of the Related Art

Fire resistant glass and fire protective glass (also designated as fireproof glass and fire barrier glass), as well as fire barrier walls, are very important for safety and heat containment within commercial buildings and other structures. Many designs of these fire-screen glazings and related fire-screen products include two glass panes with an interlayer made of various mesh materials, mineral materials, rubber materials and/or polymer materials. Typical interlayer materials include, but are not limited to metal meshes, ceramic layers and high performance thermoplastic polymer film layers.

While interlayer compositions for use within fire-screen glazings and related fire-screen products are common in the functional glass glazing product and related product art, such interlayer compositions are nonetheless not entirely without problems. For example, use of a wire mesh interlayer within a fire-screen glazing is limited due to poor aesthetics of the final fire-screen glazing product, and easy cracking of the fire-screen glazing product at high temperatures. In addition, ceramic interlayers for fire-screen glazings and related products are comparatively expensive and typically generally also brittle. Similarly, certain high performance thermoplastic polymer film materials within fire-screen glazings and related fire-screen products are generally expensive.

Desirable are additional economically attractive fire-screen glazings and related fire-screen products that provide improved fire-screen properties.

### SUMMARY

Embodiments include: (1) a multilayer interlayer polymer film for use within a fire-screen glazing or a related fire-screen product (i.e., such as but not limited to a fire-screen wall); and (2) the fire-screen glazing or the related fire-screen product that includes the multilayer interlayer polymer film. Embodiments also include a method for fabricating the fire-screen glazing or related fire-screen product.

In particular a fire-screen-glazing or related fire-screen product in accordance with the embodiments is designed as a glass laminate using the multilayer interlayer polymer film which in turn comprises: (1) a core layer comprising one of a sulfur containing thermoplastic polymer material and a fluorine containing thermoplastic polymer material; (2) at least one intermediate layer laminated to the core layer and comprising the other of the sulfur containing thermoplastic polymer material and the fluorine containing thermoplastic polymer material; and (3) at least one skin layer laminated to the at least one intermediate layer and comprising a thermoplastic polyurethane material.

Under certain circumstances, the embodiments also contemplate that an intermediate layer comprising a fluorine containing thermoplastic polymer material may be omitted to provide a multilayer interlayer polymer film that includes a core layer comprising a sulfur containing thermoplastic polymer material and a skin layer comprising a thermoplastic polyurethane material.

The embodiments contemplate that the core layer, the intermediate layer and the skin layer are each separate layers with specific polymer material compositions as described. As well, the embodiments also contemplate that the sulfur containing thermoplastic polymer material does not include a fluorine containing thermoplastic polymer material and the fluorine containing thermoplastic polymer material does not include a sulfur containing thermoplastic polymer material.

Within the embodiments, the sulfur containing thermoplastic polymer material may be selected from the group including but not limited to polysulfone (PS), polyphenylenesulfone (PPS), polysulfide (PSf) and polyphenylenesulfide (PPSf) sulfur containing thermoplastic polymer materials, as well as their blends, alloys or modifications.

The multilayer interlayer polymer film layers that comprise the foregoing sulfur containing thermoplastic polymer materials, fluorine containing thermoplastic polymer materials and thermoplastic polyurethane polymer materials may be combined in large numbers to provide a total thickness of a multilayer interlayer polymer film “sandwich” that meets particular requirements for a total thickness of a multilayer interlayer polymer film structure used in a fire-screen glazing or related fire-screen product, such as but not limited to a fire-screen wall product.

General schematic cross-sectional diagrams of multilayer interlayer polymer film glass laminates in accordance with the embodiments are shown in FIG. 1A (before lamination) and FIG. 1B (after lamination. Within FIG. 1A and FIG. 1B, G represents a glass layer, C represents a core layer, I represents an intermediate layer and S represents a skin layer.

Primary non-limiting exemplary structures of different embodiments of glass-multilayer interlayer polymer film laminates in accordance with the embodiments are as follows:
Version 1: Glass/TPU/Polysulfone/TPU/Glass
Version 2: Glass/TPU/THV/Polysulfone/THV/TPU/Glass
Version 3: Glass/TPU/Polysulfone/THV/Polysulfone/TPU/Glass
Version 4: Same as version 2, but the Polysulfone and THV material layers repeat as films of thinner gauge.
Version 5: Same as version 3, but the Polysulfone and THV material layers repeat as films of thinner gauge.
Version 6: Same as version 4 and version 5, but the TPU layer repeats between repeating sets of Polysulfone and THV.

The disclosed multilayer interlayer polymer film and related fire-screen glazing or fire-screen product in accordance with the embodiments may successfully replace fire-screen products such as but not limited to fire-screen doors, fire-screen walls and fire-screen glazings made using metal wire meshes, or alternatively made using purely fluoropolymer interlayers. The disclosed and embodied multilayer interlayer polymer film and related fire-screen glazing or fire-screen product in accordance with the embodiments may also effectively compete against ceramic interlayer based fire-screen glazings or related fire-screen products and super tempered fire-screen glazings or related fire-screen products in the commercial and residential building construction industry.

A particular multilayer polymer film in accordance with the embodiments includes a core layer comprising a sulfur containing thermoplastic polymer material. The particular multilayer film also includes at least one skin layer laminated to the core layer and comprising a thermoplastic polyurethane polymer material.

Another particular multilayer polymer film in accordance with the embodiments includes a core layer comprising one of a sulfur containing thermoplastic polymer material and a fluorine containing thermoplastic polymer material. This other particular multilayer polymer film also includes at least one intermediate layer laminated to the core layer and comprising the other of the sulfur containing thermoplastic polymer material and the fluorine containing thermoplastic polymer material. This other particular multilayer polymer film also includes at least one skin layer laminated to the at least one intermediate layer and comprising a thermoplastic polyurethane polymer material.

A particular glass laminate in accordance with the embodiments includes a multilayer polymer film located interposed between a first glass layer and a second glass layer, where the multilayer polymer film includes: (1) a core layer comprising one of a sulfur containing thermoplastic polymer material and a fluorine containing thermoplastic polymer material; (2) at least one intermediate layer laminated to the core layer and comprising the other of the sulfur containing thermoplastic polymer material and the fluorine containing thermoplastic polymer material; and (3) at least one skin layer laminated to the at least one intermediate layer and comprising a thermoplastic polyurethane polymer material.

A particular method for fabricating a glass laminate in accordance with the embodiments includes assembling a stack comprising a first glass layer and a second glass layer having interposed

therebetween: (1) a core layer comprising one of a sulfur containing thermoplastic polymer material and a fluorine containing thermoplastic polymer material; (2) at least one intermediate layer laminated to the core layer and comprising the other of the sulfur containing thermoplastic polymer material and the fluorine containing thermoplastic polymer material; and (3) at least one skin layer laminated to the at least one intermediate layer and comprising a thermoplastic polyurethane polymer material. The particular method also includes treating the stack to form a glass laminate.

### BRIEF DESCRIPTION OF THE DRAWINGS

The objects, features and advantages of the embodiments are understood within the context of the Detailed Description of the Embodiments, as set forth below. The Detailed Description of the Embodiments is understood within the context of the accompanying drawings, that form a material part of this disclosure, wherein:

FIG. 1A and FIG. 1B shows a pair of schematic cross-sectional diagrams of a fire-screen glazing in accordance with the embodiments prior to lamination (FIG. 1A) and subsequent to lamination (FIG. 1B).

FIG. 2 shows a tabular diagram of materials compositions used in a series of examples of a fire-screen glazing in accordance with the embodiments.

FIG. 3 shows a graph of Fire Protection Duration in Minutes performance for the series of examples of the various types of fire screen glazings whose materials compositions are illustrated in the tabular diagram of FIG. 2.

FIG. 4 shows a graph of Surface Temperature versus Time for thermal resistance testing of a plurality of fire-screen glazings, some of which are fabricated within the context of the embodiments.

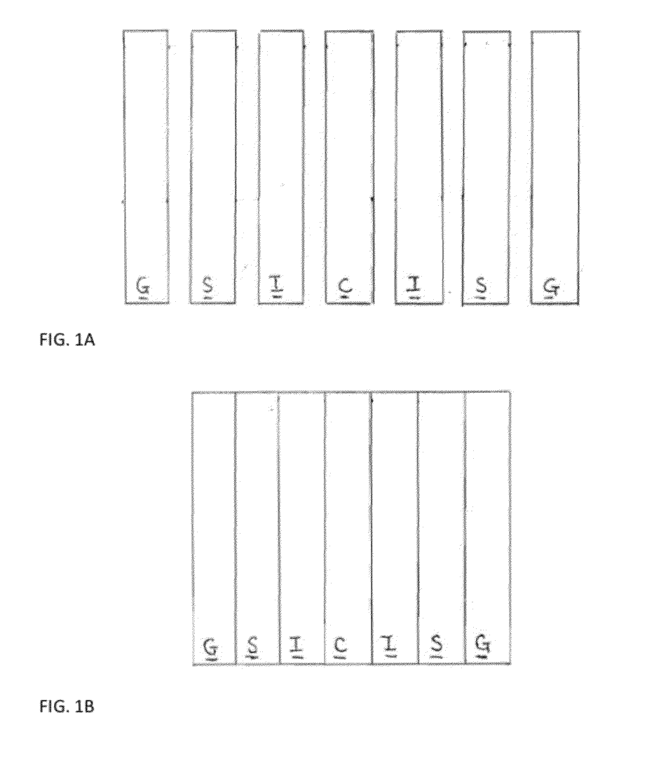

### DETAILED DESCRIPTION OF THE EMBODIMENTS

Primary aspects of the multilayer interlayer polymer film and the related fire-screen glazing or related fire-screen products that may be fabricated using the multilayer interlayer polymer film in accordance with the embodiments are as follows.

The multilayer interlayer polymer film and related fire-screen glazing or fire-screen product is based upon a combination of: (1) a thermoplastic polyurethane (TPU) polymer material, preferably a fire-retardant type and grade of TPU material (as as skin layer that may have a thickness from about 0.5 to about 10 mils), (2) a fluorine containing thermoplastic polymer material, preferably a ternary fluoro-copolymer such as but not limited to THV and/or other fluorine containing polymer materials (as a layer that may have a thickness from about 0.5 to about 30 mils in one of a core layer and an intermediate layer); and (3) a sulfur containing thermoplastic polymer material such as but not limited to polysulfone (PS), polyphenylenesulfone (PPS), polysulfide (PSI) and polyphenylenesulfide (PPSf) polymer material, as well as their blends, alloys or modifications (as a layer that may have a thickness from about 10 to about 100 mils in the other of the core layer and the intermediate layer).

In some applications, a fluorine containing thermoplastic polymer material layer within a multilayer interlayer polymer film in accordance with the embodiments may be omitted.

The sulfur-containing thermoplastic polymer materials have strong fire resistance, high melting points, high clarity, and are much less expensive than any fluorine containing thermoplastic polymer material, thus providing technical and economic advantages for the fire-screen glazing and related fire-screen products in comparison to existing fire-screening glazings or related fire-screen products in the construction industry. Due to the very high polarity of their macro-molecules the sulfur containing thermoplastic polymer materials exhibit high bondability to glass and other polymer surfaces, thus keeping the glass panes of a multilayer interlayer laminated fire-screen glazing intact in the event of breakage or fire. It is also considered within the context of the embodiments that these polymer films may also be corona-treated at ambient conditions (in air, at room temperature) for exceptionally high adhesion to glass and various polymers including the polymers from the selected group of high temperature sulfur containing thermoplastic polymer materials. Corona treatment of a polymer film surface may be conducted using a device providing a frequency of about 10,000 hertz and an electrical power of about 20-25 KV for a very short time period in a range from a fraction of a second to about 1 second.

The melting points and melt viscosity of THV and other usable fluorine containing thermoplastic polymer materials, and the above designated sulfur containing thermoplastic polymer materials, are relatively close to each other. The melt viscosities of these thermoplastic polymer materials differ, but nonetheless these differences are in the range lower than one to one and a half orders of magnitude (<10 times), that allows their co-extrusion, co-lamination and other processing technologies. Thus, fabrication of the multilayer interlayer polymer film and related fire-screen glazing or fire-screen product in accordance with the embodiments is not impeded.

Additional aspects of the multilayer interlayer polymer film and related fire-screen glazing or fire-screen products in accordance with the embodiments are as follows.

Within the context of a fire-screen glazing or fire-screen product, the embodiments contemplate that particular glass layers may be selected from the group including but not limited to crystallized glass, soda glass, borosilicate glass, keraglass and other mineral glass materials, as well as glass with various special coatings, and also polycarbonates, acrylics, and other transparent polymer glass-type materials, as well as combinations of any of the above mineral glass materials and polymer glass-type materials.

The multilayer interlayer polymer film in accordance with the embodiments may contain an additional layer of TPU positioned between the glass panes and layers of THV and polysulfone-type thermoplastic polymer materials to provide an increased toughness, flexibility and enhanced bonding to glass, and to each other. TPU is inherently fire resistant (has fire retardant properties) and shows high adhesion to glass, THV, and to sulfur-containing thermoplastic polymer materials. Nevertheless use of fire retardant types of TPU such as aromatic-type polymers or compositions with flame retardant additives is generally preferred to aliphatic types of TPU.

The multilayer interlayer polymer film in accordance with the embodiments may contain numerous combinations of film layers made of THV and other thermoplastic fluoropolymer polymer materials, TPU, and sulfur-containing thermoplastic polymer materials selected from the above group including but not limited to polysulfone, polyphenylelesulfone, polysulfide, polyphenylenesulfide, and their derivatives, blends and/or alloys. The layers in this case may be made thinner, and the whole combination of component polymer layers should meet the given total desired thickness of a desired multilayer interlayer polymer film.

The light transmittance of a fire-screen glass-multilayer interlayer laminate is controlled by the grades and properties of the sulfur-containing thermoplastic polymer materials and the TPU materials. For example, if a clear and transparent polysulfone polymer is used, then the glass-interlayer laminate construction has a very high clarity at thickness up to at least 120 mil (3,000 mcm or 3 mm). If the multilayer interlayer polymer film is made using a less transparent polysulfone and/or polysulfide, or other materials with relatively high haze and low optical transparency, then the optical properties of the fire-screen product can be adjusted to make a semi-opaque or opaque fire-screen glazing or other fire-screen product. In addition, if the layer of TPU has a large thickness (10 mils and thicker), this layer also can cause increase in haze of the glass-multilayer interlayer polymer film laminate.

The TPU is used as a layer providing a very high adhesion and impact resistance of the fire-screen glazing or related fire-screen product. The TPU layer may have a thickness from 0.2 mil (5 mcm) to 50 mil (1,250 mcm, or 1.25 mm), but it is preferable to use TPU layers in the range from 0.5 mil (12.5 mcm) to 10 mil (250 mcm), and most preferably from 1 mil (˜25 mcm) to 5 mil (125 mcm). The thickness of the TPU layer depends on the application of the glazing. TPU shows high transparency and low haze up to the thickness of ˜10 mils (˜250 mcm), and better up to ˜6 mils. The TPU film of such optimal thickness and lower, (1-6 mils) is sufficient to provide high impact resistance of glass laminates in impact tests using ball drop and canister bag testing procedures, and at the same time shows very high transparency and low haze. Thus, if a transparent fire-screen glazing is desired, then it is preferably to use TPU film 10 mil and thinner, and most preferably 1-5 mil thick. For this purpose both aliphatic and aromatic-type resins are suitable due to their high light transmittance, low haze (<0.3%) and high impact resistance. Aromatic-type materials as well as TPU modified with flame retardant additive packages are preferred from the fire-resistance properties point of view. For semi-opaque and opaque fire-screen glazings and fire-screen walls TPU film can be made thicker (depending on the wall dimensions), perhaps up to 15 mils (375 mcm, or 0.375 mm), and of the special aromatic-based flame retardant grades of TPU such as materials of the ZHF series by Lubrizol Corporation, including compositions with special fire retardant additive packages.

Glass laminates made according to this disclosure easily achieve a fire timing rating from 30 minutes to 90 minutes (where the most common requirement in the industry for many fire-screen glazings and related fire-screen products is a 30 minutes rating). Variations on thickness of the multilayer interlayer polymer film may provide structures having 30 minutes to 3 hours fire rating capabilities.

Thermoplastic polyurethane (TPU) resins of both types (i.e., aliphatic and aromatic) are available in the form of pellets for film extrusion, and also as pre-extruded films from various vendors including but not limited to Huntsman Corporation (Krystalflex). Lubrizol Corporation, Bayer (A series), Argotec Co. (Greenfield, Mass.), BASF and Bemis Company.

For example, the following grades of TPU by Lubrizol Corporation (ZHF and AG series) supplied under the trade name Estane™ show a high quality performance in the multilayer interlayer polymer films in accordance with the embodiments. These grades include but are not limited to Estane™ aromatic non-halogenated flame retardant (NHFR) grades such as ZHF 95AT3, ZHF 90AT2, and others, as well as halogenated aromatic ether grades such as 58370, and aliphatic grades AG 9550; AG 8451, AG 4950, and AG 4350. A preference, though, should be given to TPU aromatic and non-halogenated grades with a combination of low specific gravity ˜1.07-1.10 g/cmm (for high yield of film per pound of resin), light transmission not lower than 85%, and preferably in a range 90-95%, lowest haze (<0.3%), and tear strength (according to ASTM D624, die C) higher than 290 lb/in (6 kg/mm), and in a range 290-440 lbs/in (6.0-9.1 kg/mm). Compounds and compositions of series Estane™ ZHF are based on aromatic-type TPU with flame retardant additive packages. They do not have super high clarity and low haze typical for aliphatic resins of the AG series by Lubrizol Corporation. Commonly used material AG 8451 has an extremely low haze (<0.3%) of film with thickness up to 5 mils.

Another example of a suitable polymer film is the aliphatic polyether TPU D-3290 by Bemis Company (MA, USA) having density 1.07 g/ccm and available in thickness in the range from 6 mil to 10 mil with transparency ˜95% along with high mechanical properties.

TPU has an outstanding adhesion to glass and a number of various polymer materials, very high impact resistance (including at low temperatures), high clarity (at limited thickness, in the range from 0.2 mil (5 mcm) to 10 mil (250 mcm), very high UV-light resistivity and long shelf life. The thicker a TPU polymer material layer is, the stronger is its protection of a relatively brittle sulfur-containing thermoplastic polymer material layer from impact loading. However, a thicker TPU material layer will have a higher haze of film, and thick TPU layers cannot be used for optical glazing products, but can be successfully used for translucent, semi-opaque and opaque fire-screen glazing and related fire-screen products. TPU film with thickness from 0.2 mil (5 mcm) to 40 mil (1000 mcm, 1 mm) can be used according to the current disclosure, but TPU film 1.0 mil and thinner is very hard to incorporate into manufacturing processes due to tackiness, thus films with thickness in the range from 1.5 mil (˜12.5 mcm) to 10 mil (250 mcm) are preferred, and the most preferred are TPU film in the range from 1.5 mil (˜37.5 mcm) to about 6 mil (˜150 mcm).

The fluorine containing thermoplastic polymer material layer preferably comprises at least about 85 wt. % of THV copolymer, a thermoplastic elastomeric ter-copolymer containing segments of tetrafluoroethylene (TFE), hexafluoropropylene (HFP), and vinylidene fluoride (VDF). Properties and methods of manufacturing THV resin are described in many patents and articles (see, for example, M. Friedman et al., U.S. Pat. No. 5,908,704 and a number of references cited therein). The preferred THV block or graft copolymers are commercially available polymers comprising a molar ratio of TFE:HFP:VDF of about 42-60:20-18:38-22. Also useful herein are blends of THV with other fluoropolymers including, but not limited to, fluorinated ethylene-propylene copolymer (FEP), perfluoroalkoxy polymer (PFA), perchlorotetrafluoroethylene (PCFE), ethylenetetrafluoroethylene copolymer (ETFE), polyvinylidene fluoropolymer (PVDF), chloroethylenetetrafluoroethylene (ECTFE), and dichloroethylenetetrafluoroethylene (ECCTFE). A blend of THV with other fluorinated polymers may be used to offset raw material costs and improve material strength properties of THV. The above and other additional fluoropolymers exhibit greater mechanical toughness and thermal stability when blended with THV, and give a material having excellent fire resistance and thermal stability, in addition to improved mechanical strength, which may in turn allow for reduced thickness of the THV component layer within a multilayer interlayer polymer film in accordance with the embodiments.

Various fluoropolymers are available in the form of pellets of resin for extrusion of film from DuPont, and in form of pre-extruded film from 3M Company (Dyneon Division), Saint-Gobain Performance Plastics, as well as from several foreign sources. THV has various grades, which differ considerably in melting temperature and properties. Suitable THV grades for the current disclosure are grades with a higher melting point, which comes close to the melting point of a sulfur containing thermoplastic polymer material core layer. Preferred are THV 500 GZ and THV 815 GZ resins from the Dyneon Division of 3M Company having good processability into extruded film, flexibility, high clarity and fire resistance. Grades of THV such as 815 GZ, having higher mechanical strength and especially higher melting point, are preferred for the goals of the current invention. For example THV 815 GZ melts at 224 C (˜435 F) in comparison to THV 220 G, which melts at 116 C (˜241 F).

The group of sulfur containing thermoplastic polymer materials such as sulfur containing aromatic thermoplastic polymer materials, shows very high use temperature, toughness, exceptional chemical and fire resistance, clarity, low creep, and good processability. As an example, the high performance materials from Ticona (USA and Germany) such as Ceramer™ type, contain aromatic rings and S═O chemical groups in the molecular structure. Various types and grades of high performance sulfur-containing thermoplastics are available for example from Solvay Advance Polymers (Alpharetta, Ga., USA). Polysulfone (PS), chemical name poly(oxy-1,4-phenylenesulfonyl-1,4-phenyleneoxy-1,4-phenylene (1-methylethylidene) 1,4-phenylene, is a rigid, high-strength, transparent, high heat deflection temperature, HDT (174 C/345 F) material with high chemical, hydrolytic and oxidative stability, produced by Solvay under the trade mark Udel™. The grades Udel™ P-1700 NT 11, P-3500 NT LCD, and P-3703 NT LCD are suitable for a multilayer interlayer polymer film and a fire-screen glazing or related fire-screen product in accordance with the embodiments. Polyphenylenesulfone (PPS), chemical name 4-(4-hydroxyphenyl)phenol, 4-(4-hydroxyphenyl)sulfonylphenol, Radel™ by Solvay, is a super-tough transparent thermoplastic with HDT higher than PSU (207 C/405 F). Grades of Radel™ 5000 CL 301 and Radel™ 5000 NT are preferred in accordance with the embodiments. PPS (Radel™) is more expensive but it is less brittle than PS (Udel™) and it is easier to handle. Polyethersulfone (PES) has approximately the same HDT as Radel™ and better chemical resistance than PSU Udel™. Modified PPS Acudel™ and Mindel™ have lower costs but they are suitable for fabrication of semi-opaque and opaque glazing and fire walls only.

The concept of using the above sulfur-containing aromatic thermoplastic polymer materials as a core layer film or an intermediate layer film in the multilayer interlayer polymer film for fire-screen glazings and related fire-screen products in accordance with the embodiments is based on the following properties of these materials: (1) high flame resistance and inherent flame retardant properties; (2) high HDT (up to 207 C/445 F and higher); (3) high mechanical strength, stiffness, and dimension stability over a wide temperature range; (4) high clarity and low haze due to amorphous morphology; (5) extremely high chemical resistance and resistance to gamma or electron beam radiation; and (6) relatively low price in comparison with fluorine containing thermoplastic polymer materials (for example THV).

It is also important that these materials possess ability for repeated steam autoclavability, and that they do not emit hazardous or other dangerous chemicals and volatile gases during heating and burning.

Of the limitations of the selected polymer materials is their relatively high density (in the range from 1.23 g/ccm to 1.37 g/cmm), which is, however, much lower than the density of fluoropolymers (1.7-2.7 g/ccm). In addition, another limitation is their relatively high brittleness in the context of sulfur containing thermoplastic polymer materials. For this reason, the use of a skin layer of TPU and/or an intermediate layer of THV having extremely high impact resistance is desirable for the fire-screen glazing or related fire-screen product of the embodiments. Another reason for using TPU and THV skin and intermediate layers is the need for compensation of the difference in shrinkage of glass and PS and/or PPS, which during cooling of the glass laminate can lead to breakage of the glass panes. The thickness of TPU layer should be chosen at a highest level while still avoiding an unacceptably high optical haze. As has been considered in the current disclosure the optimal TPU film thickness is in the range from 1 mil (25 mcm) to 10 mils (250 mcm), and the most preferable film is in the range from 2 mils (50 mcm) to 6 mils (150 mcm).

All sulfur containing thermoplastics such as PS and PPS (for example Udel™ and Radel™ by Solvay's division Ajedium) as well as their blends/alloys can be extruded into films without serious problems. However, special attention should be given to preparation (pre-drying) of these resins and to the choice of proper and optimal extrusion equipment, especially the screw design as discussed below.

Thinner layers of PS, PPS and others can be combined into thicker layers by “baking” them together at temperature 200 C (˜392 F) and higher. This procedure allows for combining PS and PPS in one core layer for lowering the costs (PS is less expensive than PPS). The temperature of lamination of the suggested interlayers to glass should not exceed 240 C (˜464 F) to avoid the increase of haze of the film and final product. In addition a large number of pores may occur in the film at temperatures starting at 250-270 C (˜482-518 F).

### EXPERIMENTAL

The technology and equipment used to fabricate samples of glass-multilayer interlayer polymer laminates used a “vacuum bag.” In each trial a multilayer film stack was placed between two glass panes and positioned in a vacuum station (“vacuum bag”), where it was subjected simultaneously to heating and vacuum “pressure” processing.

### 1. Lamination Equipment

The working set of equipment included the following main units: (1) two heated plates; (2) a vacuum system; and (3) a vacuum “bag.” The plates were 230 mm×230 mm×25 mm in dimensions (9.2″×9.2″×1″), made of aluminum and equipped with flat silicone heating devices and thermocouples. The bottom plate was positioned stationary upon support “legs” 60 mm (2.4″) high, and the upper plate was removable. Each plate had an independent heating control system installed with a high precision thermal controller (+/−0.5 degree C.).

The vacuum system included a pre-vacuum pump, three-way flow directing unit, vacuum-meter, and a set of tubing. The vacuum bag was made of silicone sheets 1 mm (40 mil) thick and dimensions 500 mm×500 mm (20″×20″), positioned opposite each other into a multilayer bag. The upper sheet/layer had an inlet for connecting vacuum tubing, and the bottom layer (between the inlet and the corner of the “sandwich” to be laminated) had an installed mesh and/or tubing, which provided vacuum to the laminated structure. Without such a unit the vacuum would cause the collapse of the bag and prevent the vacuum from reaching the lamination zone. The layers of the bag were glued together at three sides by applying silicone glue. The bag remained free (loose) at the fourth side.

### 2. Lamination Method

The working plates were pre-heated to a chosen temperature. The experimental glass-film structure was positioned in the middle of the vacuum bag cavity, and the open (loose) side of the bag was sealed by tape. The tubing line of the vacuum system was connected to the inlet of the vacuum bag. Then the vacuum pump was switched on, and the vacuum reached a value close to 1 atm. The vacuum bag was positioned between the pre-heated working plates, and the bag was heated for approximately 10 minutes under vacuum.

After these actions the bag was removed from the plates and cooled to the ambient temperature. After this operation the system was disassembled and the glass-plastic laminate was recovered from the system. All samples were subjected to tests of various properties as described below.

### 3. Preparation of Raw Materials for Extrusion and Lamination

TPU has to be pre-dried at temperatures in the range from 115 C to 120 C (˜240-250 F). Increase of the temperature above the indicated level may lead to very strong tackiness of TPU pellets and/or film, and makes the handling of the material in any form very difficult. It was observed that the clarity of TPU improves after pre-drying of pellets and lamination of film with other layers and glass.

THV and other fluorine containing thermoplastic polymer materials do not need pre-drying due to the extremely low moisture absorption. However, pre-heating of the resin is definitely recommended for easier melting of the polymer and shortens the melting section of the extruder. This is especially helpful for co-extrusion of THV and other fluorine containing thermoplastic polymer materials for various multilayer interlayer polymer film structures. Pre-heating temperature for THV was kept in the range from 100 C (212 F) to 125 C (˜257 F). Time of pre-heating depended also on application of vacuum during the drying and heating process.

For sulfur containing thermoplastic polymer materials such as available from Radel™ and Udel™ was preferred to pre-dry for 3-4 hours in standard industrial vacuum driers at temperature in the range 160-180 C (˜320-356 F) depending on the applied vacuum during drying and heating. Pre-drying of these high performance materials before their melt processing into films was desirable for avoiding such drawbacks as striking, splaying, and bubbling of an extruded film. Pellets can be dried in ovens with circulating hot air or in dehumidified hopper dryers. To dry in an oven the pellets must be spread on trays to 1″-2″ depth and dried for ˜3.5 hours at 135-163 C (275-325 F). The resin should be handled carefully to prevent re-absorption of moisture from the atmosphere. To dry in a hopper, the inlet air should have a dew point of 32 C (25 F) and be preheated to 135-163 C (275-325 F), and the residence time should not exceed ˜3.5 hours.

### 4. Testing Procedures

Fire rating tests and certifications for both US and European product standards focus on flame and fume protection and the resistance to radiant heat penetration and impact force. Fire-rated glass is commonly used to describe glass that keeps a fire contained thus protecting buildings and occupants from flames, smoke and hot gasses. The ability of the glass to maintain this barrier is measured in 20, 30, 45, 60, 90, 120, 180 and 240 minutes. This classification of products designated “fire-protective” if the glass holds up 30 minutes and longer, include super tempered glass, wire glass, fluoropolymer laminate glass and ceramic glass.

Higher performing fire-rated glass products have not only the ability to contain a fire but also to provide a barrier to heat. This type of glass is specified in areas containing combustible valuables or escape routes like stairwells and hallways. The classification of products designated “fire-resistant” include intumescent glass (gel poured between two sealed glass panes) and multiple glass pane laminates (fluoropolymers or intumescent layers bonding many layers of glass together), and the fire-resistant performance is also measured in minutes.

Fire-rating standards, codes and governing bodies vary and have slightly different certification requirements. Most fire-ratings adhere to a standard time temperature curve that simulates the conditions of a fire in a closed furnace. Temperatures of 538° C. (1000° F.) are achieved in 5 minutes and gradually increase to 1093° C. (˜2000° F.) after 180 minutes. Test samples are glazed into the openings of the furnace to withstand the maximum time/heat without allowing smoke or flames to penetrate through the test sample. A collapse or hole in the test sample more than ⅓ the test sample size is considered a failure. The test provides a fire-protection time rating that must meet building code compliance or the product cannot be used in particular building code applications.

Heat-radiant and fire-resistant tests are done in the same fashion as the foregoing tests, but temperature readings are recorded from the non-fire glass surface and the time stamp occurs when this surface exceeds 163° C. (325° F.). Products that achieve fire-resistant ratings of 60 minutes are difficult to manufacture, prone to post installation defects and generally demand a very high expense.

Fire-rated glass that is appropriately specified for a building application may be required to also meet impact standards. This additional certification subjects multiple samples to a 100 pound impact ball bombardment. A category I rating is tested at a one-time ball drop from a distance of 45.8 cm (or 18″) and a category II rating is tested at a one-time ball drop distance of 122 cm (1.22 m or 48″). A glazing material may be qualified for use in both Category I and Category II products if it meets the impact requirements for Category II.

A glazing material will pass the impact test if the sample meets any one of the criteria: (1) when breakage occurs no opening shall develop in the test sample through which a 76 mm (3″) diameter solid steel sphere can pass through; (2) when breakage occurs, the 10 largest particles together shall weigh no more than the weight of 64 sq cm (10 sq″) of the original sample; and (3) the specimen does not break.

Finally, in the United States and Canada (only) in order to seek a fire-rating greater than 20 minutes, the tested glass is immediately put through a fire hose test. While the glass is still hot from the furnace, it is sprayed with water from a fire-hose at a pressure of at least 30 PSI. The sample must stay intact to pass the test. This could be a contributing factor to lower cost fire-rated products in Europe as opposed to the incumbent products in the United States, which must pass this difficult test. Authorities having jurisdiction may opt to bypass this test, but there is no guarantee.

All samples (specimens) were tested for light transmittance, haze, impact and fire-screening properties.

Haze values of the laminates were measured using a “Haze Guard Plus” haze meter by BYK Gardner Corporation (USA, Germany) as indicated in ASTM Method D-1003.

Light transmittance was measured using ANSI standard Z26.1 T2.

Impact properties of the laminates were measured using the following standard tests: (1) ball drop Test—DIN 52338, and (2) canister bag test—CEN/TC129/WG13/N42.

Fire resistance was measured using ISO standard 834 tests. According to this standard, fire-screening glass must pass at least 30 (thirty) minutes of fire testing.

### 5. Examples

The following examples are specific illustration of embodiments. These examples illustrate the embodiments and are not intended to limit the scope of the invention. The first examples are described for comparison only. According to properties of standard fire-screen glazing with fluoropolymer interlayers, glass laminates are often fabricated using THV interlayer film with thickness in the range from 5 mil (125 mcm) 50 mil (1,250 mcm). However, according to patent and technical literature, these glasses pass the impact and fire-screening tests described above, only when the THV interlayer has thickness not less than 14 mil (356 mcm), preferably 40-50 mil (1,000-1,250 mcm), and it is made of high molecular weight (MW) THV grades with MW in the range from 200,000 to 500,000 (and/or MFR in the range from 5 to 25 g/10 min. at 200 C and 5 kg load) and VTES is used as a coupling agent in concentration from 0.5 to 1.7 wt. %.

Various layer structures can be designed according to embodiments depending on the desired applications, optical requirements and costs. The designs and film thicknesses described below may be considered as typical but not limiting for the goals of this disclosure.

TPU skin layers within fire-screen glazing and related fire-screen products in accordance with the embodiments are used for several functions: (1) as an adhesive layer (to glass); (2) as a tie layer providing adhesion of various components to each other; and (3) as a layer protecting other films and increasing the impact resistance of the fire-screen glazing or related fire-screen product. A thickness of a TPU film may vary in the range from 0.2 mil (5 mcm) to 10 mil (˜250 mcm), preferably from 0.5 mil (12.5 mcm) to 5 mil (125 mcm), and most preferably from 0.5 mil (˜12.5 mcm) to 2.5 mil (˜62.5 mcm).

THV film layers according to the embodiments are much thinner than in the standard THV interlayer containing fire-screen glazing products, not thicker than 10 mil (250 mcm) in comparison to 40-100 mil (1,000 mcm-2,500 mcm). The detailed description of use of THV and other fluoropolymers (FP) such as ECTFE and ECCTFE, as interlayer in fire screening glazing, their grades and processing can be found in the U.S. Pat. No. 5,908,704 (M. Friedman et al.). THV in the embodiments is preferably used as an intermediate layer (and not as a sole core layer) as in standard fire screening glass, to provide in combination with TPU an enhanced impact and fire resistance of the product. However, a THV layer is not mandatory at all if a thick enough TPU layer is present in the glass laminate. Generally THV layer may have thickness in the range from 0 to 100 mil (2,500 mcm), but preferred are THV film components in the range from 0.5 mil (12.5 mcm) to 30 mil (1,000 mcm), and most preferred in the range from 0.5 mil (12.5 mcm) to 15 mil (375 mcm).

A lower thickness THV or its absence helps to reduce a multilayer interlayer polymer film cost in accordance with the embodiments. THV and other FP must be treated to provide a sufficient adhesion to glass and other polymer layers. THV should contain in the formulation, or its surface should be treated with, coupling agents such as vinyl-triethoxy-silane (VTES) and/or siloxane primer solutions, in quantity from 0.3 wt. % to 3 wt. %, and the THV film surface may be preliminary embossed with certain patterns to enable evacuation of air from the gap between layers during the vacuum lamination process. It should be also taken into consideration that enhancement of THV film adhesion to glass using VTES or other coupling agents usually negatively influences the optical quality of the laminate, thus increasing the haze of the product. These measures (embossing and adhesion promoters) are not required when TPU and PS or PPS are used according to the embodiments due to very high adhesion provided by these polymer components in the laminate.

All layers within a multilayer interlayer polymer film in accordance with the embodiments may vary in thicknesses and comprise various grades of resins (see above). The individual components may be extruded or co-extruded. Also some pre-extruded films can be acquired from reliable vendors as listed above in this disclosure.

The multilayer interlayer polymer film in accordance with the embodiments typically have symmetrical arrangements, but asymmetrical placements of components are also possible in terms of positions of individual film layers and their thicknesses.

PS and PPS can be used individually or in combinations with each other for cost reduction purposes and to improve optical properties of the laminate, since PS Udel™ is more clear (transparent) and colorless in comparison to PPS Radel™ but it is somewhat more expensive. The total thickness of sulfur containing high performance core layers (containing PS or PPS and others or combinations of them) can vary in the range from 2 mil (50 mcm) to 250 mil (6,250 mcm), preferably from 5 mil to 150 mil, and most preferred from 15 mil (375 mcm) to 120 mil (3,125 mcm). The thinner the interlayer the clearer and less expensive is the glass-polymer laminate. But the fire protection capability can be provided on a higher level (in terms of longer time of protection, etc.) if the interlayer is thick enough.

### Examples 1-7

In these 7 (seven) examples (for comparison) glass laminates were made using THV as an interlayer. THV 200 G, 500 G, and 850 G were extruded into films of different thickness: 10, 20, 30, 40, and 50 mil using a laboratory film extrusion line equipped with a single screw with length to diameter ration L:D=24:1, and a flat/cast extrusion die 12″ (300 mm) wide. The final films had the width of 10″ (250 mm). The THV pellets were pre-heated at ˜80 C (˜176 F) and extruded at temperatures increasing along the extruder in the range from 185 C to 275 C (˜365 F to ˜527 F). Thickness uniformity of film samples was at the level of +/−10-12%.

The laminates were fabricated using standard clear soda-lime-silicate glass sheets of 3 mm thickness and dimensions 10″×10″ (250×250 mm). Lamination was performed using the “vacuum bag” technology described above and simulating the standard vacuum autoclave technology in terms of temperature (˜140 C/284 F), pressure (˜12 Bars), and time (20-30 minutes) parameters.

Properties of the laminates fabricated using THV interlayer films are shown in the Table 1. Haze values and fire resistance time are the average values for 5 specimens in each example. Impact (ball drop) test results are given as a number of samples, passing the test out of 5 (five) specimens for each example (the requirement is that at least 4 specimens out of 5 should pass).

TABLE 1
Properties of Glass Laminates with THV Interlayer Films (Examples 1-7).
Example

| | | Film | | | | |
|---|---|---|---|---|---|---|
| | | thick- | | Ball drop | Fire | |
| | THV | ness, | | test | resistance | |
| Exam- | resin | mil | Haze | results, | test, | Pass |
| ple | grade | (mcm) | % | passed of 5 | minutes | Y/N |
| 1. | 200 G | 30 mil | 2.10% | 4 failed | 15 min. | Failed |
| 2. | 500 G | 30 mil | 2.65% | 2 failed | 20 min. | Failed |
| 3. | 500 G | 40 mil | 3.55% | 1 failed | 26 min. | Failed |
| 4. | 500 G | 50 mil | 4.95% | 0 failed | 30 min. | Failed |
| 5. | 815 G | 30 mil | 3.75% | 1 failed | 26 min. | Failed |
| 6. | 815 G | 40 mil | 4.65% | 0 failed | 34 min. | Failed |
| 7. | 815 G | 50 mil | 5.55% | 0 failed | 37 min. | Failed |

As seen from the data of Table 1, THV of higher MW such as 815 G, provides better impact and fire resistance, and when the interlayer is thick enough (30-50 mil) a laminated glass product is able to pass the ball drop and 30 minutes fire resistance time tests. However, the haze values of glass laminates made using THV is relatively high, and causes failure due to values higher than 4% acceptable according to industry standards. Specimens made with multilayer interlayers polymer films of various grades of THV and thicknesses fail either the impact or fire resistance time, or haze values.

### Examples 8-11

In these examples TPU Estane™ AG 8451 by Lubrizol Corporation, 2 mil thick, PPS Radel™ 5500 by Solvay, 35 mil thick, and PS Udel™ P 1700 by Solvay, 35 mil thick, were used respectively, or as indicated, in the following structures:

### Example 8

| | | | |
|---|---|---|---|
| Polymer: | TPU- | PPS- | TPU |
| Grades: | AG 8451 | Radel ™ 5500 | AG 8451 |
| Thickness: | 2.5 mil | 35 mil | 2.5 mil |

### Example 9

| | | | |
|---|---|---|---|
| Polymer: | TPU- | PS- | TPU |
| Grades | AG 8451 | Udel ™ P 1700 | AG 8451 |
| Thickness: | 2.5 mil | 35 mil | 2.5 mil |

### Example 10

| Poly- | TPU - | PPS - | TPU - | PS - | TPU - | PPS - | TPU |
|---|---|---|---|---|---|---|---|
| mer: | | | | | | | |
| Grades: | the same as in example 8 | | | | | | |
| Thick- | 2 mil | 20 mil | 2 mil | 20 mil | 2 mil | 20 mil | 2 mil |
| ness: | | | | | | | |

### Example 11

| | | | | | | | | |
|---|---|---|---|---|---|---|---|---|
| Polymer: | TPU - | THV - | PPS - | TPU - | PS - | TPU - | THV - | TPU |

| | |
|---|---|
| Grades: | 2 mil THV film made of grade 815 G by Dyneon; |
| | other polymers are the same as in examples 8-10. |

Test results for Examples 8-11 are shown below in Table 2.

TABLE 2
Properties of Laminates Examples 8-11

| | Total Film | | Ball | Fire | |
|---|---|---|---|---|---|
| Example | thickness, | | drop | resistance, | Pass |
| ## | Mil (mcm) | Haze % | test | min | Y/N |
| 8. | 39 mil | 1.25% | 1 failed | 38 min | Passed |
| | (97.5 mcm) | | | | |
| 9. | 39 mil | 1.10% | 1 failed | 33 min | Passed |
| 10. | 68 mil | 2.50% | 0 failed | 68 min | Passed |
| 11. | 52 mil | 2.35% | 0 failed | 81 min | Passed |

In accordance with the data of Table 2, multilayer interlayer polymer film compositions in accordance with the embodiments provide: (1) lower haze; (2) good ball drop impact resistance; and (3) very high fire resistance time (see example #10 made without THV an average 68 minutes, and 11, with a thin THV intermediate layer an average 81 minutes).

### Examples 12-24

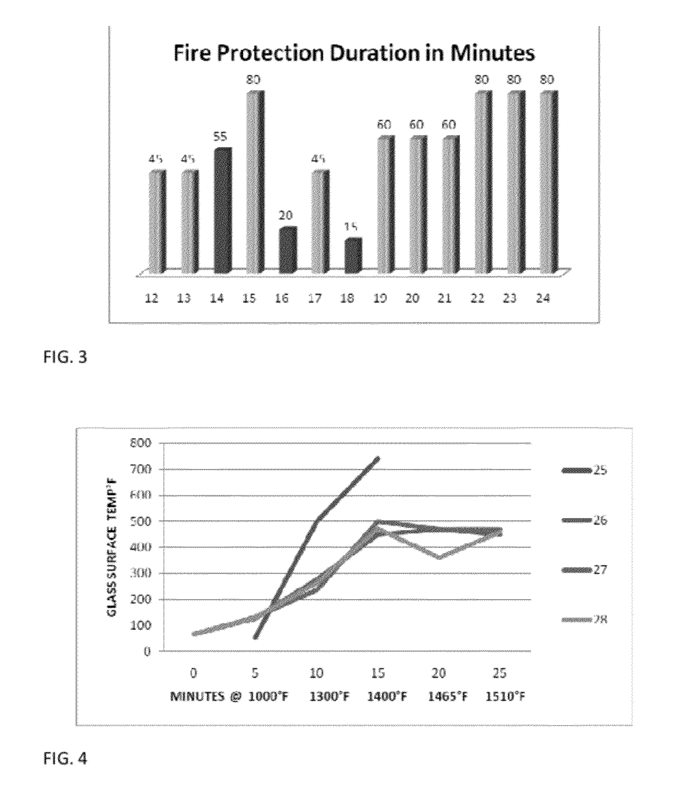

Several groups of polymer interlayer structures were used in these series of experiments: group I (examples 12-13 respectively); group II (examples 14-15); group III (examples 16-18); group IV (examples 19-21), and group V (examples 22-24). Examples 16 and 18, were made using flame retardant silicone rubber for comparison, and they failed after 15-20 minutes of fire tests (see the graph of FIG. 3, as described below).

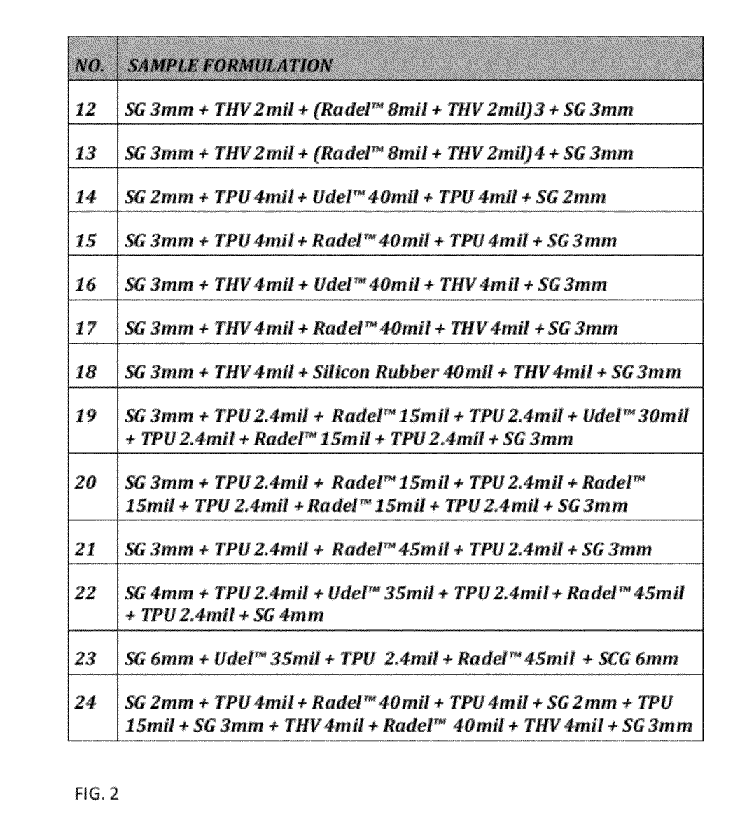

Particular multilayer interlayer polymer film compositions and resulting glass laminate constructions are illustrated in the table of FIG. 2 (where SG represents silicate glass). Results of particular fire protection time periods are illustrated in the graph of FIG. 3.

As is seen from the graph of FIG. 3, samples 12 & 13 testing was concluded at the 45 minute time interval. Sample 12 and 13 both surpassed the 45 minute rating. Samples 14 & 15 testing was concluded at 80 minutes and sample 15 passed this rating. Sample 14 failed at 55 minutes. Samples 17 & 18 testing was concluded at 45 minutes and sample 17 passed this rating. Sample 16 failed at 20 minutes and sample 18 failed at 15 minutes. Samples 19, 20 & 21 testing was concluded at 60 minutes. All 3 samples surpassed the 60 minute rating. 22, 23 & 24 testing was concluded at 80 minutes. All 3 samples surpassed the 80 minute rating.

From the data of FIG. 2 and FIG. 3, all samples tested in accordance with the embodiments provide a much higher time of fire protection than silicone rubber when used as an interlayer material. Silicon rubber as an interlayer material in accordance with the foregoing examples causes a multilayer interlayer polymer film glass laminate to fail after 15-20 minutes. For comparison purposes fluorine containing polymers, such as fluoropolymer (THV-based) multilayer interlayer polymer films, fail after duration of ˜30-40 minutes in fire tests.

Use of the PPS (Radel™) and PS (Udel™) provides the fire test duration for the glass laminate on the level of at least 45-81 minutes and up to about 120 minutes and even longer (some of these tests just have been terminated at 81 minutes). Multilayer interlayer polymer films using film components made of PPS Radel™ provided a higher fire-resistance time rating than PS Udel™, however the longest fire-resistance protection time is achieved when PPS is combined with PS and/or THV layers (perhaps some kind of “synergetic effect”). Increasing the thickness of the core layers, PPS (Radel™) and the PS (Udel™), increases the fire-rating for both the compartmentalization of flames and fumes as well as the heat radiance protection.

The addition of individual glass panes increases the radiant heat protection. Thicker glass panes (6 mm) are less effective than a combination of thinner glass panes (3 mm+3 mm) as the heat waves may be deflected by each surface area interface. Furthermore, the placement of 3 mm glass panes to the hot side of a multilayer interlayer polymer film laminate is effective for holding together the glass. Thinner panes melt in a slurry and are less likely to crack and fall away from the laminate as fractured heavier glass panes. This keeps the inner layer from premature exposure to the flames. Effective radiant heat deflection will presumably allow a 6 mm glass pane positioned to the exterior (non-fire side) to act as a temperature insulator. This should achieve and sustain a lower surface temperature. Sulfur containing polymers (such as Radel™ and Udel™, and their mixtures) are brittle and their mechanical impact properties as well as handling is strongly improved when they are encased with TPU which acts as impact protector (“cushion”). The use of even very thin 1-2 mil TPU helps to improve significantly the toughness, tear resistance, tensile strength and elongation properties of interlayer films, and provides good impact resistance for the ball drop test and the hose stream test.

FIG. 4 shows a graph of Glass Surface Temperature versus time for several additional samples in accordance with the embodiments. The graphs on FIG. 4 show typical results of measurements of the temperature (in F) on the surface of a glass pane (opposite to the flame side) versus time (minutes). These graphical results are drawn based in each case on average data of five temperatures measured in four corners and in center of each glass pane. Example 25 (darkest and steepest curve) shows typical data for glass laminate with a standard THV-based interlayer (Glass-THV-Glass). It is observed that the temperature on the pane's surface grows practically linear with time and reaches about 750 F (˜399 C) in 15 minutes. This curve will eventually level out at a relatively high temperature of about 1000 F (˜538 C) in approximately 30-35 minutes, which is much higher than the temperature required by the safety standards. Examples 26, 27 (highest curve at 15 minutes) and 28 (lowest curve at 20 minutes) reflect typical data for glass laminates with multilayer interlayer polymer films designed in accordance with the embodiments. Example 26 for example, used a combination of glass-TPU-PPS-TPU-glass. Example 27 used the same combination of materials, but the core layer combined PPS and PS (Radel™ and Udel™).

Example 28 also used a core layer including PPS and PS, but also combined with an additional relatively thin layer of THV. They all show a much lower heat transfer and lower temperature on the surface of the opposite glass pane ˜470 F (˜243 C), reachable in ˜15 minutes, practically without further changes. Further reduction of surface temperature can be achieved by increase in thickness of one or both glass panes, from 3 mm to 4-6 mm, due to extremely low heat transfer of glass. In this case the international standard of 325 F (˜163 C) can be achieved.

All references, including publications, patent applications, and patents cited herein are hereby incorporated by reference in their entireties to the extent allowed, and as if each reference was individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening.

The recitation of ranges of values herein are merely intended to serve as a shorthand method of referring individually to each separate value falling within the range, unless otherwise indicated herein, and each separate value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not impose a limitation on the scope of the invention unless otherwise claimed.

No language in the specification should be construed as indicating any non-claimed element as essential to the practice of the invention.

It will be apparent to those skilled in the art that various modifications and variations can be made to the present invention without departing from the spirit and scope of the invention. There is no intention to limit the invention to the specific form or forms disclosed, but on the contrary, the intention is to cover all modifications, alternative constructions, and equivalents falling within the spirit and scope of the invention, as defined in the appended claims. Thus, it is intended that the present invention cover the modifications and variations of this invention provided they come within the scope of the appended claims and their equivalents.

Therefore, the embodiments are illustrative of the invention rather than limiting of the invention. Revisions and modifications may be made to methods, materials, structures and dimensions of a multilayer interlayer polymer film and related fire-screen glazing or related fire-screen product in accordance with the embodiments while still providing a multilayer interlayer polymer film and related fire screen glazing of related fire screen product in accordance with the invention, further in accordance with the accompanying claims.

What is claimed is:

1. A multilayer polymer film comprising:
a core layer comprising a sulfur containing thermoplastic polymer material; and
at least one skin layer laminated to the core layer and comprising a thermoplastic polyurethane polymer material.

2. The multilayer polymer film of claim 1 wherein the multilayer polymer film is symmetric with respect to the core layer.

3. The multilayer polymer film of claim 1 further comprising at least one glass layer laminated to the at least one skin layer.

4. A multilayer polymer film comprising:
a core layer comprising one of a sulfur containing thermoplastic polymer material and a fluorine containing thermoplastic polymer material;
at least one intermediate layer laminated to the core layer and comprising the other of the sulfur containing thermoplastic polymer material and the fluorine containing thermoplastic polymer material; and
at least one skin layer laminated to the at least one intermediate layer and comprising a thermoplastic polyurethane polymer material.

5. The multilayer polymer film of claim 4 wherein the multilayer polymer film is symmetric with respect to the core layer.

6. The multilayer polymer film of claim 4 wherein the fluorine containing thermoplastic polymer material is selected from the group consisting of THV, FEP, ECTFE, ECCTFE and blends of THV with other fluoropolymer materials.

7. The multilayer polymer film of claim 4 wherein the sulfur containing thermoplastic polymer material is selected from the group consisting of polysulfone, polyphenylenesulfone, polysulfide, polyphenylenesulfide and blends, alloys or modifications of polysulfone, polyphenylenesulfone, polysulfide and polyphenylenesulfide polymer materials.

8. The multilayer polymer film of claim 4 wherein a thickness of a fluorine containing thermoplastic polymer material layer is from about 0.5 mil to about 30 mil.

9. The multilayer polymer film of claim 4 wherein a thickness of a sulfur containing thermoplastic polymer material layer is from about 10 mil to about 100 mils.

10. The multilayer polymer film of claim 4 wherein a thickness of the skin layer is from about 0.5 mil to about 10 mil.

11. A glass laminate comprising:
a multilayer polymer film located interposed between a first glass layer and a second glass layer, the multilayer polymer film comprising:
a core layer comprising one of a sulfur containing thermoplastic polymer material and a fluorine containing thermoplastic polymer material;
at least one intermediate layer laminated to the core layer and comprising the other of the sulfur containing thermoplastic polymer material and the fluorine containing thermoplastic polymer material; and
at least one skin layer laminated to the at least one intermediate layer and comprising a thermoplastic polyurethane polymer material.

12. The glass laminate of claim 11 wherein the glass composite construction is symmetric with respect to the core layer.

13. The glass laminate of claim 11 wherein each of the first glass layer and the second glass layer is selected from the group consisting of crystallized glass, soda glass, borosilicate glass, keraglass, other mineral glass materials, polycarbonates, acrylics, and other transparent polymer glass-type materials.

14. The glass laminate of claim 11 wherein the fluorine containing thermoplastic polymer material is selected from the group consisting of THV, FEP, ECTFE, ECCTFE and blends of THV with other fluoropolymer materials.

15. The glass laminate of claim 11 wherein the sulfur containing thermoplastic polymer material is selected from the group consisting of polysulfone, polyphenylenesulfone, polysulfide, polyphenylenesulfide and blends, alloys or modifications of polysulfone, polyphenylenesulfone, polysulfide and polyphenylenesulfide polymer materials.

16. The glass laminate of claim 11 wherein a thickness of a fluorine containing thermoplastic polymer material layer is from about 0.5 mil to about 30 mil.

17. The glass laminate of claim 11 wherein a thickness of a sulfur containing thermoplastic polymer material layer is from about 10 mil to about 100 mils.

18. The glass laminate of claim 11 wherein a thickness of the skin layer is from about 0.5 mil to about 10 mil.

19. A method for fabricating a glass laminate comprising:
assembling a stack comprising a first glass layer and a second glass layer having interposed therebetween:
a core layer comprising one of a sulfur containing thermoplastic polymer material and a fluorine containing thermoplastic polymer material;
at least one intermediate layer laminated to the core layer and comprising the other of the sulfur containing thermoplastic polymer material and the fluorine containing thermoplastic polymer material;
at least one skin layer laminated to the at least one intermediate layer and comprising a thermoplastic polyurethane polymer material; and
treating the stack to form a glass laminate.

20. The method of claim 19 wherein the treating includes a thermal treating.

21. The method of claim 19 wherein the treating includes a vacuum treating.

22. The method of claim 19 wherein the treating includes a thermal treating and a vacuum treating.

23. The method of claim 19 wherein at least one of the core layer, the intermediate layer and the skin layer is corona treated prior to assembling the stack.
